(19) United States
(12) Patent Application Publication
(10) Pub. No.: US 2012/0247302 A1
(43) Pub. Date: Oct. 4, 2012

(54) CUTTING DEVICE

(75) Inventor: Donal Cronin, Rockforest (IE)

(73) Assignee: CUISINE DE FRANCE, Clondalkin, Dublin, IE (IE)

(21) Appl. No.: 13/496,787

(22) PCT Filed: Sep. 17, 2010
(86) PCT No.: PCT/EP2010/063739

§ 371 Date: Jun. 12, 2012

(30) Foreign Application Priority Data
Sep. 18, 2009 (IE) S2009/0716

(51) Int. Cl. B26D 3/08

(52) U.S. Cl. 83/883

(57) ABSTRACT

A device for scoring a dough article prior to baking is provided. Score lines are imparted to the dough piece which act to pre-portion the dough. The dough pieces are scored so that sections are easily torn off into individual pre-determined portion sizes at the point of consumption, with the scoring being insufficiently weak so that the portions separate during production steps. The cutter device (1, 2) has a frame (10, 20) from which depends a supporting member (18, 28) with a base (15, 25). Also depending from the frame (10, 20) are cutting blades (12, 22, 13, 23) with scoring edges (14, 24), which edges are optionally notched. At least a portion of the edges of the blades are located closer to the frame than the base of the supporting member to limit the depth to which the edges can penetrate a dough piece, thereby providing a score on the dough piece when the cutting device is lowered over it, with the supporting member base resting on a board which carries the dough piece.

The present invention relates to a cutting device, in particular to a cutting device suitable for pre-portioning a piece of dough.

The concept of “tearing and sharing” bread has existed for some time. This relates to a bread product which comprises individual portions which are baked together as a single loaf with deep score lines provided in it. At the point of consumption individual portions are pulled away causing the individual portions to separate from the loaf along the deep score lines. The loaf can thus easily be shared amongst the persons present. However it is normally difficult on a mass scale to produce tear and share bread that provides consistent torn portion sizes.

Previously ‘tear and share’ bread was only available from smaller bakeries where the process for making this type of bread was a manual process. The primary reason for this is that the tool used to cut into the dough without cutting wholly through it is a straight metal scraper device. This tool requires several strokes to portion a standard sized dough piece. Furthermore use of the scraper device is highly dependent on the skill of the person using it. Care is required to ensure that the user correctly positions the scraper device on the dough piece to ensure even portioning of the dough piece and even score depth across the dough. This tool is cumbersome to use. It is not suitable for use in automated lines where up to 5,500 loaves of bread are prepared for baking.

It is therefore an object of the present invention to provide a cutting device that is designed to pre-portion a piece of raw dough prior to baking into consistent portion sizes.

A further object is to provide a cutting tool capable of producing a pre-portioned loaf which resists any tendency for the loaf to fall apart into the portions before reaching the consumer.

It is acknowledged that the term ‘comprise’ may, in varying jurisdictions be provided with either an exclusive or inclusive meaning. For the purpose of this specification, and unless otherwise noted explicitly, the term comprise shall have an inclusive meaning so that it may be taken to mean an inclusion of not only the listed components it directly references, but also other non-specified components. Accordingly, the term ‘comprise’ is to be attributed with as broad an interpretation as possible within any given jurisdiction and this rationale should also be used when the terms ‘comprised’ and/or ‘comprising’ are used.

According to a first aspect of the invention there is provided a dough cutting device suitable for scoring a dough piece to pre-portion it, comprising;
a frame having an upper side and an under side,
the under side of the frame having depending therefrom a supporting member having a base with a free end distal from the under side of the frame and at least two adjoining cutting blades spaced apart from the supporting member on the under side of the frame,
each cutting blade having a scoring edge distal from the under side of the frame, the base of the supporting member extending distally beyond at least a portion of the scoring edge of the cutting blades.

Therefore, the base terminates distally further from the under side of the frame and at least a portion of the scoring edges terminate relatively proximally to, or closer to, the under side of the frame than does the free end of the base. Generally, both the supporting member with base and the cutting blades depend substantially perpendicularly from the under side of the frame. This arrangement provides that when the device is lowered against a board on which a dough piece is resting, a free end of the base of the supporting member rests on the surface of the board about the dough piece with at least a part of the scoring edge of the cutting blades held spaced nearer to the underside of the frame then is the base of the supporting member, to form a gap between at least a portion of the scoring edge of the cutting blades and the board surface.

The gap or gaps so formed between the bases of the supporting member and the scoring edges allows the scoring edges of the cutting blades to score the upper surface of a dough piece without fully cutting through the piece when the frame is placed about the dough piece.

The advantage of the cutting device is that it is easy to use in a bakery production line prior to dough being baked or partially baked. Specifically the gap or spacing between the free end of the base of the supporting member and at least a portion of the scoring edge of the cutting blades on the under side of the frame prevent the cutting device from scoring or cutting fully through the dough, thus enough continuous dough is left below at least part of the score line to hold the bread together while still allowing a consumer easily to tear off portions of bread once the bread is fully cooked.

Conveniently, in one arrangement the scoring edges of the adjoining cutting blades lie in a common plane. When the cutting device is placed over a dough piece, the supporting member contacts a board on which a dough piece is resting while the scoring edges of the cutting blades, or at least a portion of those scoring edges, do not contact the board. Instead, at least part of the scoring edges of the cutting blades score the upper side of the dough piece but do not cut wholly through it.

In one aspect, the full length of the scoring edge is spaced distally apart from the free end of the base of the supporting member.

In another aspect, one or more sections of the scoring edges of the cutting blades lie in the same plane as the free end of the base of the supporting member and the remaining section or sections are spaced closer to the underside of the frame. In this latter aspect, at least one of the adjoining cutting blades includes a plurality of notches on the scoring edge. Conveniently the notches serve to provide a score line of varying depth on the dough piece along their length, thus forming areas of greater and lesser weakness in the dough along the score line which easily tear when the final baked product is pulled apart into individual portions whilst at the same time providing unscored or more shallowly scored areas along the line where the dough is thicker and which serve to hold the bread portions together during production. Optionally the notches may take any shape which provides the function that some parts of the cutting edge score less deeply into the dough than other parts. Indeed, the lower parts (that is to say, the parts furthest from the under side of the frame) of the notched scoring edge may be sized, positioned and/or shaped to cut wholly through the dough, resulting in a perforated score line in the dough. Alternatively, those lower unnotched sections of the notched scoring edge may be sized, positioned and/or shaped to penetrate into the dough without cutting wholly through it at any point, giving rise to a score line of varying depths in the dough corresponding to the relative positions of the more deeply-scored unnotched parts of the scoring edges and the more shallowly-scored notched parts of the scoring edges.

Thus, the notched-edged cutting blades may be shaped if desired so that the lowest parts of the scoring edges cut wholly through the dough, thereby effectively resulting in a perforated score line. This is achieved by spacing a part or parts of the scoring edges co-terminous with the free end of the base, with the scoring edge of at least part of the cutting blade being in the same plane as the free end of the base. Alternatively, the lower parts of the scoring edges may be held spaced from the base of the supporting member such that the dough is not wholly cut through, but rather scored to deeper depths and shallower depths by the notched cutting edges. This is achieved by having the unnotched part or parts of the scoring edge of the cutting blade terminating relatively proximally nearer the under side of the frame than the free end of the base.

In a further aspect of the invention, the supporting member comprises a skirt or leg positioned on the under side of the frame and extends generally perpendicularly therefrom toward the free end, which defines the base of the supporting member. Ideally, the base of the supporting member includes at least two feet, which further prevent the user from pushing the scoring edges of the cutting blades too far into the dough. Advantageously, the feet are adjustable to enable the distance of the base of the supporting member relative to the under side of the frame to be altered. This enables a user to adjust the depth of the score line formed into the dough without having to alter the cutting blades. The same cutting device can consequently be used for a wide range of products that may require cuts of a different depth due to the type of dough, the recipe being used and/or the shape of the dough piece, including in particular the height of the dough piece.

By adjusting the feet and by selecting the depth of the gap or space between the blade edges and the feet to suit a particular dough piece, one can ensure that the piece of dough is scored appropriately so that the dough/bread does not fall apart before the consumer gets the opportunity to break off the pieces.

In a further aspect of the invention the adjoining cutting blades are positioned such that one of the cutting blades extends through another cutting blade. In this aspect of the invention the cutting blades are positioned at an angle to each other. Ideally the cutting blades are positioned at an angle of approximately 90° relative to each other. The positions of the cutting blades relative to each other is not limited to this angle and any suitable desired angle can be used. Conveniently the cutting device is not limited to two cutting blades; it is possible to use any desired number of cutting blades. Advantageously the number and arrangement of the cutting blades in the cutting device of the invention enables the dough piece to be pre-portioned into consistent sized sections with scores that are deep enough for easy separation of the dough into individual portions at the point of consumption, yet with sufficient unscored dough at the score lines to resist the dough separating into portions during baking, packaging etc. before reaching the consumer. It will be understood that the dough piece can be of any desired shape for example rectangular, square, circular, wedge or irregular shape. The cutting blades can be positioned at any required angle to produce a portion of any desired shape or size, for example, wedge shaped.

In a further aspect of the invention the cutting device is a handheld portable device. Conveniently in this aspect of the invention the cutting device is provided with at least one handle attached to the frame. Optionally the handle of the cutting device is positioned centrally on the upper side of the frame. In an alternative aspect the cutting device is provided with one or more handles on side members of the frame. Conveniently in a further aspect at least two handles are provided on opposing side members of the frame. In this further aspect, the cutting device could also be provided with a handle positioned centrally on the upper side of the frame. The advantage of having more than one handle on the cutting device is that any adverse ergonomic effects are minimized by providing more than one holding position.

In a further aspect the frame of the cutting device includes a cover. Optionally the cover comprises a mesh or perforated cover which assists a user in correctly positioning the cutting device over a dough piece to ensure even pieces when the bread is pulled apart by a consumer. In use the cutting device is positioned over the piece of dough and pressed into the dough to form the score lines. Conveniently the cutting device is easily used by bakery personnel requiring minimum human force to form the score lines within the piece of dough.

The cutting device of the invention enables an operator to insert score lines into a dough piece at a rate that matches the capacity of the line without adding an excessive amount of labour thus producing a new product with significant customer appeal with relatively little disruption to the production line.

Ideally the cutting device of the present invention is formed from a suitable material acceptable for use in food production. In addition the cutting device is ideally designed without moving parts. Thus it is safe to use and easy to clean.

In view of its simple construction and ease of use, the cutting device of the present invention can be used by operators after a minimum amount of training time.

In a further aspect of the invention the cutting device is readily modified for use with an automated system, optionally including a control or a vision system.

The invention will now be described more particularly with reference to the accompanying drawings, which show by way of example only, two embodiments of a cutting device of the invention.

In the drawings,

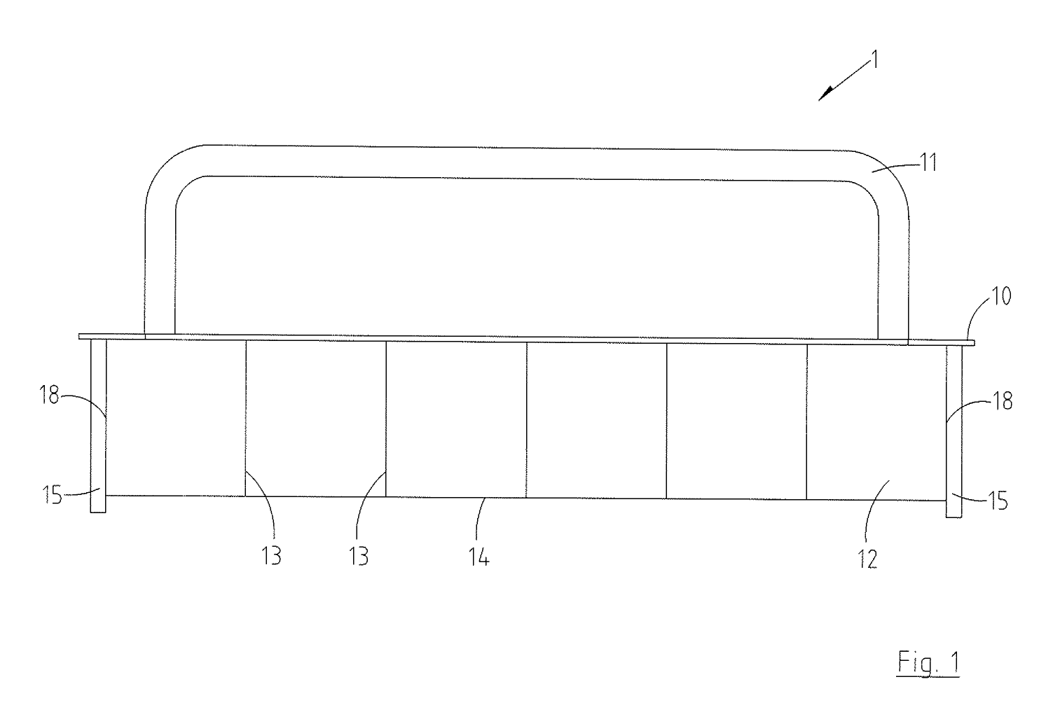

FIG. 1 is a plan view of a first embodiment of a cutting device according to the invention;

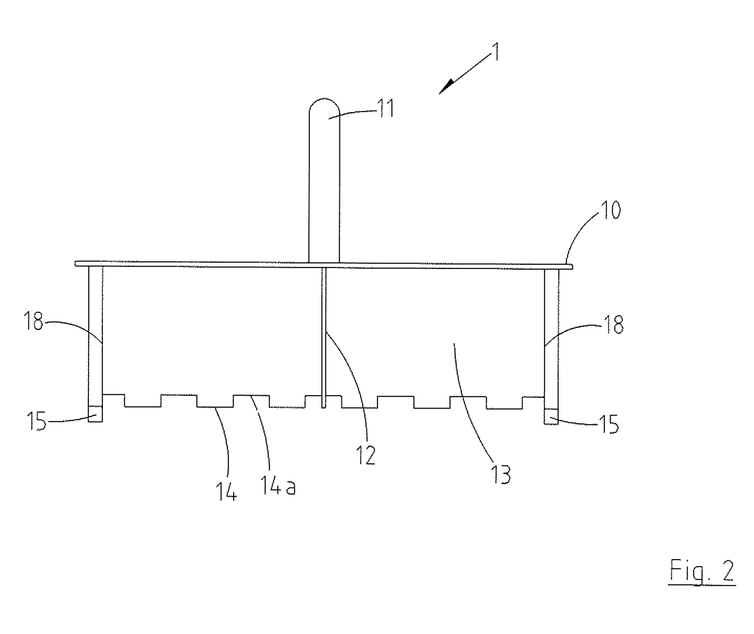

FIG. 2 is an end elevation view of the cutting device of FIG. 1;

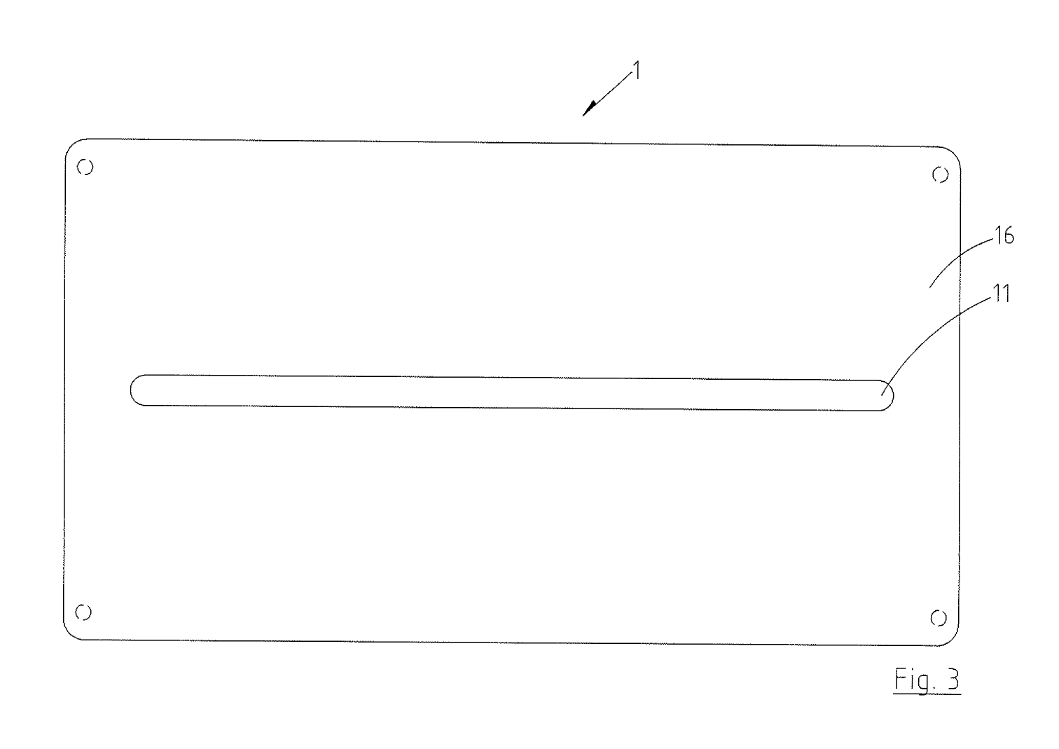

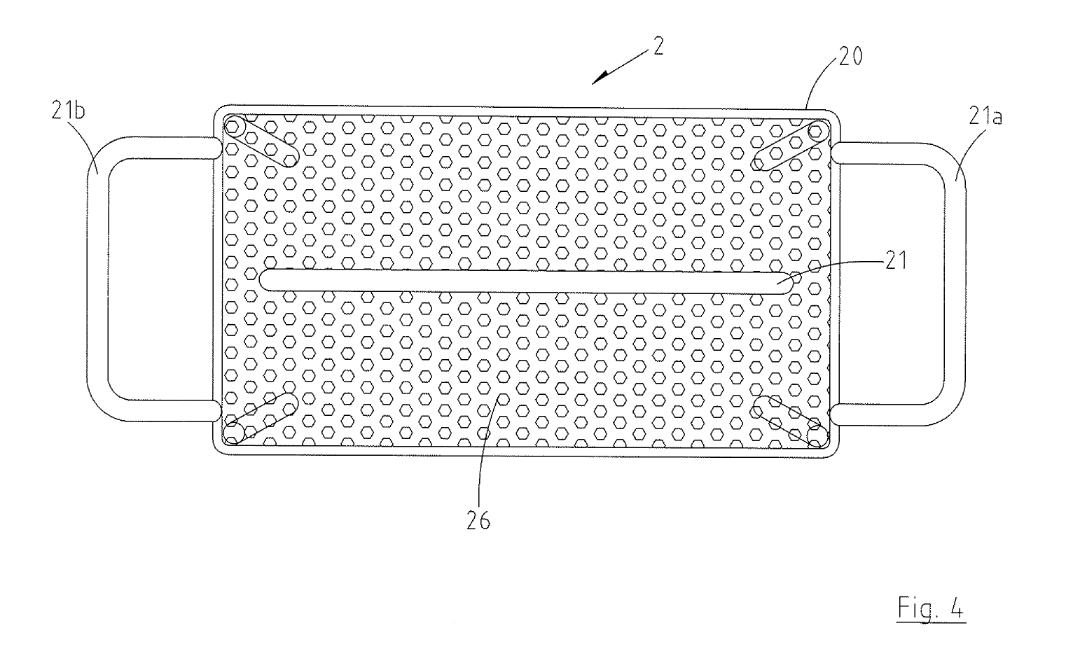

FIG. 3 is an elevation view of the cutting device of FIG. 1;

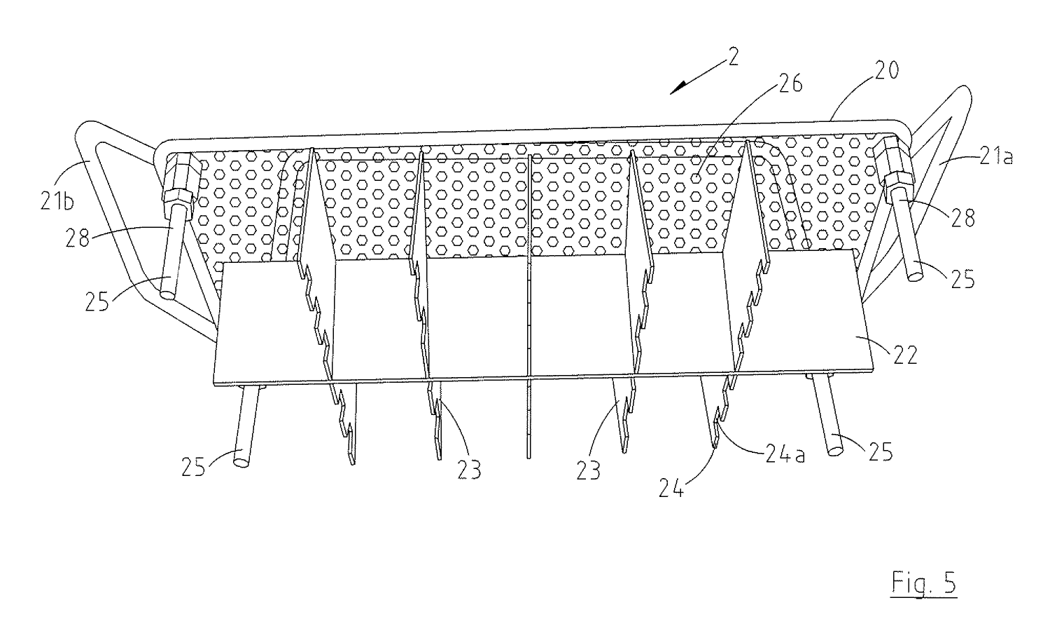

FIG. 4 is an elevation view of a second embodiment of the cutting device of the invention;

FIG. 5 is a plan view of the cutting device of FIG. 4; and

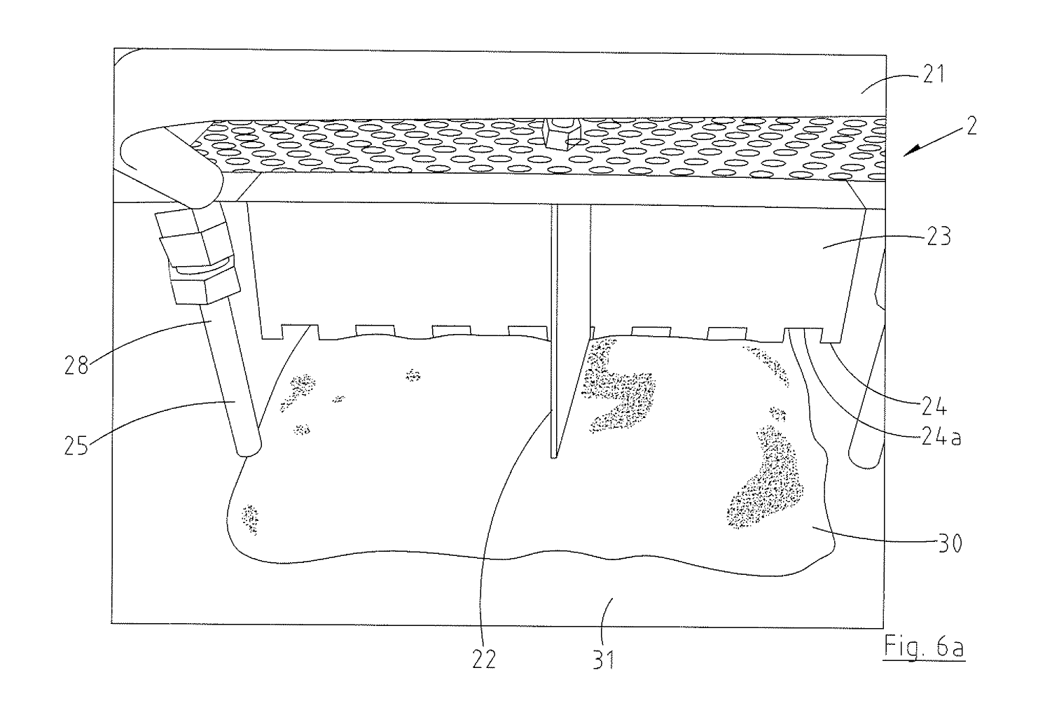

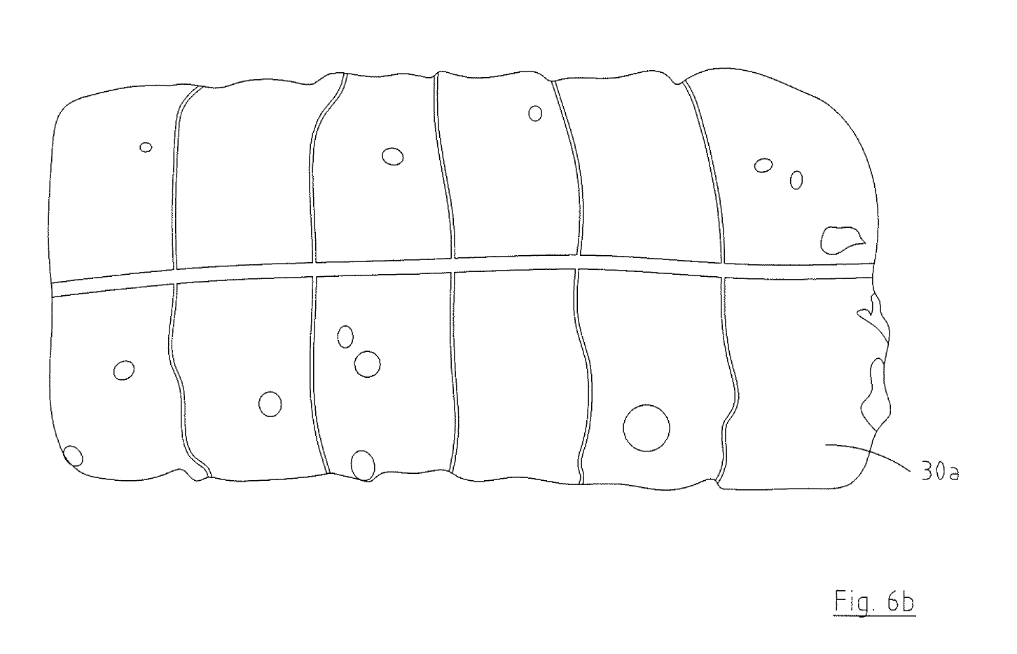

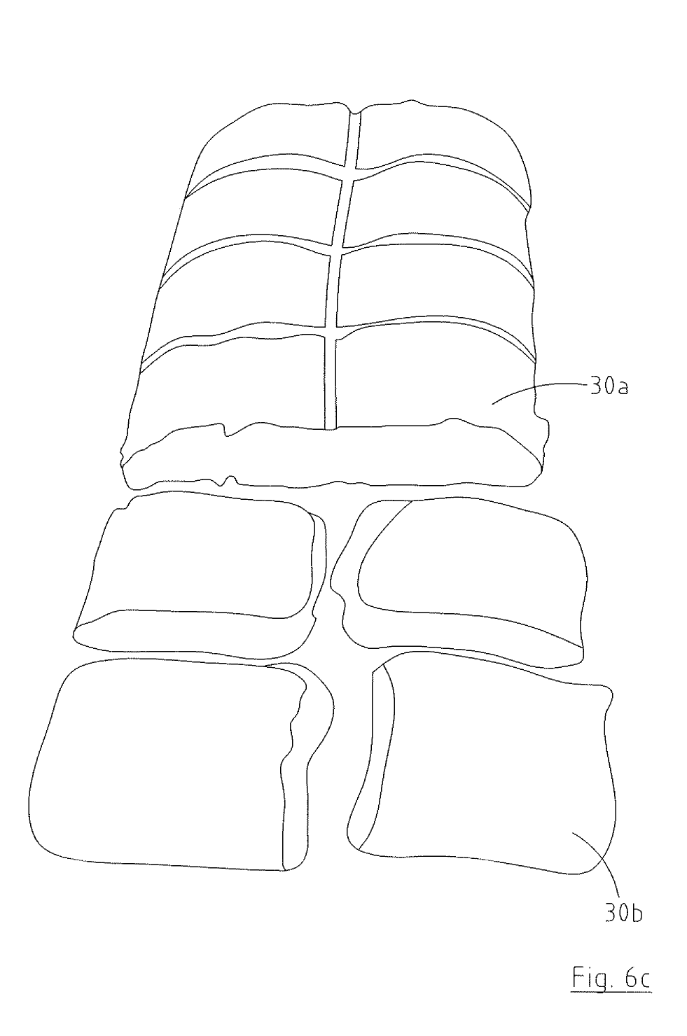

FIGS. 6a to 6c show a sequence of the operation of the cutting device partially cutting down through the dough prior to baking, the dough once baked and the bread being pulled apart into consistent sized portions.

Referring now to the drawings and specifically to FIGS. 1 to 5 there are shown two embodiments of cutting devices of the invention, referred to by numerals 1 and 2 respectively. Each embodiment of cutting device 1, 2 comprises a frame 10, 20 having an upper side and an under side. Depending from the frame 10, 20 is a supporting member 18, 28 with a base (which may have feet) 15, 25 at a free end thereof. Hereinafter the supporting member will be referred to as a skirt or leg 18, 28. The supporting member is not limited to this type of support and any suitable support mechanism known to a person skilled in the art can be used to achieve the purpose of pre-portioning the dough.

Effectively the supporting member provides a stop which comes to rest against a board carrying the dough, and which therefore limits the final spacing of the score lines by limiting where the scoring edges of the blades terminate in the dough when the base of the supporting member rests on the board.

Referring specifically to FIGS. 1, 2, 5 and 6a, there is shown a plurality of adjoining cutting blades also attached to the under side of the frame 10, 20 comprising a central cutting blade 12, 22 and a plurality of cross blades 13, 23. Each cutting blade 12, 13, 22, 23 has a scoring edge 14, 24 remote from the under side of the frame 10, 20. The cross blades 13, 23 optionally have a plurality of notches 14a, 24a on the scoring edge 14, 24 to avoid a full cut through the dough occurring when the cutting device 1, 2 is pressed into a dough piece. In effect, notches 14a, 24a serve to provide a perforated score line on the dough piece along their length.

In an arrangement not shown in the drawings, the scoring edges may be unnotched, straight edges. In this arrangement, the scoring edges will stop short of the base of the supporting member so that a gap is provided between the free end of the base and the scoring edges to stop the scoring edges cutting wholly through the dough instead of merely scoring the dough.

The central cutting blade 12, 22 and cross blades 13, 23 are slotted at the top and bottoms of the blades respectively to allow cross blades 13, 23 to extend through the central cutting blade 12, 22. In the arrangement shown in the drawings, the cross blades 13, 23 extend through the central cutting blade 12, 22 at an angle of 90°. Other arrangements are possible within the scope of the invention to impart different score markings of other shapes to the dough, and hence other shapes to the final loaf and loaf portions as separable from the final baked loaf at the point of consumption.

In use, the scoring edges of the blades are pressed down into a dough piece so as to score it deeply without cutting wholly through the dough. The so-produced score lines form areas of weakness in the dough which tear easily when the final baked product is pulled apart into individual portions for consumption.

Scoring edges generally lie in a common plane and either they, or notches formed in them, are spaced closer to the frame 10 than the base (or feet) 15, 25 of the skirt or legs 18, 28. In this way, when the cutting device is placed over a dough piece, the base/feet of the skirt or legs come into contact with a board on which the dough piece is resting and act then as a stop, so that the scoring edge 14, 24 of cutting blades 12, 13, 22 and 23 score the dough piece but do not cut wholly through it.

As shown in the drawings, the base of the supporting member (skirt or legs) 15, 25 includes feet which are adjustable. Adjustable feet 15, 25 bear against an underlying board carrying the dough and thereby prevent the user from pushing the scoring edge 14, 24 of blades 13, 23 so far into the dough piece that the portions are completely separated from one another, but instead allow the user to penetrate the dough sufficiently to score it without cutting all the way through it. They also can be used to prevent the scoring edges from reaching the surface of the boards that carry the dough, thereby reducing wear and tear to the surface of the boards. The adjustable feet 15, 25 also allow various depths of score to be achieved to suit any one of numerous dough recipes and shapes available. Thus, adjustment of the feet to shorten or lengthen the distance from the base of the supporting member to the frame can be used to achieve any desired score depth in the dough piece.

In an alternative arrangement not shown in the drawings, the legs may be non adjustable or may be provided as a continuous or discontinuous skirt depending from the frame about the outer periphery of the cutting device.

Each device 1, 2 further comprises at least one handle 11, 21 attached to the frame 10, 20. In both embodiments of the cutting device 1, 2 shown in the drawings, handles 11 and 21 are positioned centrally on the upper side of the respective frames 10, 20. Handle 21 can be held and operated with two hands adjacent to one another on the handle. In the second embodiment, cutting device 2 is provided with additional handles 21a, 21b on side members of the frame 20 intermediate the upper and under sides at opposing ends of the device 2, thus providing a further option for holding cutting device 2. The purpose of this is to minimize any adverse ergonomic effects that might exist by having only one position in which the device may easily be held.

In these specific embodiments of the cutting device, each device 1, 2 is approximately 30.5 cm (12 inches) long. Conveniently the central cutting blades 12, 22 of cutting device 1 and 2 are approximately 29.2 cm (11.5 inches) long and cross blades 13, 23 are approximately 15.2 cm (6 inches) long. Cross blades 13, 23 are shown to have seven notches 14a, 24a cut into the scoring edge 14, 24. It is of course to be understood that neither the device nor the cutting blades of the device are limited to this length or number of notches, since any suitable size, length or edge pattern determined by a person skilled in the art can be used. Further, the central blades and cutting blades need not be arranged at right angles to one another, as other arrangements are equally selectable depending on the shapes of final portions desired.

Frame 10, 20 of cutting device 1, 2 further may optionally comprise a cover 16, 26. Conveniently cutting device 2 includes a mesh or perforated cover 26 which helps a user to position device 2 correctly over a dough piece to portion the dough piece accurately and ensure even portion sizes when the bread is pulled apart by a consumer.

Referring now specifically to FIGS. 6a, 6b and 6c, the process of making bread which can be easily pulled apart into consistently sized portions will now be described.

Dough pieces 30 are automatically placed on a support board 31, typically referred to as a “peel” board. For example, six pieces of dough are placed on a peel board advancing on a conveyor at a rate of twelve peel boards per minute. The dough pieces are rectangular in shape and are approximately 26.7 cm to 29.2 cm (10.5 to 11.5 inches) long and 11.4 cm to 14.0 cm (4.5 to 5.5 inches) wide. The peel boards are advanced into a retarder and held there for two hours in a controlled temperature and humidity environment. There is no major change in the footprint of the dough during this time with the exception of a minor dip in the height of each piece as the dough relaxes.

The boards 31 exit the retarder and travel on a conveyor to an oven via a docking table. At the docking table the boards pause for approximately 15 to 20 seconds. During this time a team of operators use the cutting devices 1, 2 of the invention (FIG. 6a in which cutting device 2 is shown) to cut down partially through each dough piece 30. This is achieved by centering device 2 over the dough piece 30 and then pressing down until the feet 25 come in contact with the peel board 31. Then, he or she lifts the device free of the dough piece 30, which is now scored to pre-portion the dough. Each operator has to work at a pace to ensure that every dough piece 30 is worked on before it moves from the docking table. Output is determined by aligning the cutter headcount with the dough piece rate through the docking area of the line.

It will be appreciated that by introducing some modifications, the process can readily be automated. For example, the handles can be replaced by a suspension means which would enable the cutting device to be attached to a carriage above the docking table in such a way that the cutting device could be automatically lowered onto a dough piece on a conveyor below it so as to score the dough piece. Such an automated system can conveniently be supplemented by a control system capable of detecting the position of dough pieces and ensuring that the cutting device is placed in correct register with the dough to score it in the desired fashion.

The dough pieces 30 are then peeled from the boards 31 and loaded onto an oven hearth for at least an initial bake time. Following this, the bread is cooled, optionally frozen, passed through a metal detector and packed prior to distribution. At domestic, retail store or restaurant level, the bread 30a (FIG. 6b), if previously only part baked, receives its final bake and is then passed to the consumer. The consumer can then break the bread 30a into portions 30b (FIG. 6c). Alternatively, the bread may be fully baked in the production plant ready for immediate consumption.

In the particular example shown in FIGS. 6b and 6c, the bread 30a is scored and breakable into twelve individual portions 30b, which are generally square. By varying the relative orientation between the central cutting blade and the cross blades and/or by adjusting the separation between the cross blades, other shaped portions may be formed, for example non-square rectangles, lozenge shapes, wedges and the like.

It will of course be understood that the invention is not limited to the specific details described herein, which are given by way of example only, and that various modifications and alterations are possible within the scope of the invention as defined by the appended claims.

1. A dough cutting device suitable for scoring a dough piece to pre-portion it, comprising;
a frame having an upper side and an under side,
the underside of the frame having depending therefrom a supporting member having a base with a free end distal from the underside of the frame and at least two adjoining cutting blades spaced apart from the supporting member on the underside of the frame,
each cutting blade having a scoring edge distal from the underside of the frame, the base of the supporting member extending distally beyond at least a portion of the scoring edge of the cutting blades.

2. A dough cutting device as claimed in claim 1, in which the scoring edges of the adjoining cutting blades lie in a common plane.

3. A dough cutting device as claimed in claim 1, in which the full length of the scoring edge is spaced distally apart from the free end of the base of the supporting member.

4. A dough cutting device as claimed in claim 3, in which at least one of the adjoining cutting blades includes a plurality of notches in the scoring edge.

5. A dough cutting device as claimed in claim 1, in which one or more sections of the scoring edges of the cutting blades lie in the same plane as the free end of the base of the supporting member and the remaining section or sections are spaced closer to the underside of the frame.

6. A dough cutting device as claimed in claim 5, in which at least one of the adjoining cutting blades includes a plurality of notches on the scoring edge.

7. A dough cutting device as claimed in claim 6, in which the or each section of the notched scoring edge which is co-planar with the free end of the base is sized, positioned and/or shaped to cut wholly through dough in use, resulting in a perforated score line in the dough.

8. A dough cutting device as claimed in claim 1, in which the supporting member comprises a skirt or leg positioned on the underside of the frame and extends generally perpendicularly therefrom toward the free end, which defines the base of the supporting member.

9. A dough cutting device as claimed in claim 8, in which the base of the supporting member includes at least two feet.

10. A dough cutting device as claimed in claim 9, in which the feet are adjustable to enable the distance of the base of the supporting member relative to the underside of the frame to be altered.

11. A dough cutting device as claimed in claim 1, in which the adjoining cutting blades are positioned such that one of the cutting blades extends through another cutting blade, with the cutting blades and scoring edges positioned at an angle to each other.

12. A dough cutting device as claimed in claim 11, in which the cutting blades are positioned at an angle of approximately 90° relative to each other.

13. A dough cutting device as claimed in claim 1, including at least one handle attached to the frame.

14. A dough cutting device as claimed in claim 13, in which is the handle is positioned centrally on the upper side of the frame.

15. A dough cutting device as claimed in claim 13, including one or more handles mounted on side members of the frame.

16. A dough cutting device as claimed in claim 1, in which the frame includes a cover.

17. A dough cutting device as claimed in claim 1 in which the full length of the scoring edge is spaced distally apart from the free end of the base of the supporting member.

18. A dough cutting device as claimed in claim 1 in which the supporting member includes at least two feet.

19. A dough cutting device as claimed in claim 1 in which the supporting member includes at least two feet which are adjustable to enable the distance of the base of the supporting member relative to the underside of the frame to be altered.

20. A dough cutting device as claimed in claim 19 in which the adjustable feet act as stops.
